(19) United States
(12) Patent Application Publication
(10) Pub. No.: US 2007/0116465 A1
(43) Pub. Date: May 24, 2007

(54) Systems and methods for dynamic alignment of data bursts conveyed over a passive optical net work

(75) Inventor: John J. Bieker, Plainfield, IL (US)

Correspondence Address: Dean D. Small;Armstrong Teasdale, LLP, Square 2600, One Metropolitan Square, St. Louis, MO, 63102, US

(73) Assignee: TELLABS OPERATIONS, INC.

(21) Appl. No.: 11/283,896

(22) Filed: Nov. 21, 2005

(51) Int. Cl. H04J 14/00

(52) U.S. Cl. 398/70; 398/72

(57) ABSTRACT

In accordance with certain embodiments, an optical network terminal (ONT) is provided that comprises a processor module, a serializer module and an optical transmitter. The processor module may represent an FPGA device, while the serializer may represent a SERDES, with the FPGA device and SERDES being formed as distinct and separate components. The processor module is configured to generate data bursts that are associated with time slots in a time division multiplexing transmission scheme. The processor module outputs the data bursts over parallel channels to the serializer module that, in turn, serializes the data bursts and outputs serial data bursts over a serial channel. The serializer module has a latency representing an amount of time for each of the data bursts to propagate through the serializer module from the parallel channels to the serial channel. The optical transmitter is joined to the serial channel and converts the serial data bursts to optical data bursts. The processor module determines a latency of the serializer module and controls the optical transmitter based on the latency of the serializer module. Optionally, the processor module may provide a burst enable signal that turns on and off the optical transmitter in order to align the optical data bursts with the corresponding time slots in the time division multiplexing transmission scheme.

### BACKGROUND OF THE INVENTION

This invention relates generally to passive optical networks (PONs) and, in particular, to systems and methods for dynamic alignment of data bursts relative to a time division multiplexing (TDM) transmission scheme.

Passive optical networks have been utilized in a variety of applications, such as in fiber-to-the-premises applications and fiber-to-the-curb applications. Passive optical networks typically include an optical line terminal (OLT) connected through a point-to-multipoint network to a plurality of optical network terminals (ONT). In operation, the OLT is located at the head end of the network and broadcasts data downstream to multiple ONTs. The upstream communications from the ONTs are managed based on a time division multiplexing transmission scheme, in which each ONT is assigned one or more unique time slots during which the ONT may transmit data upstream to the OLT. Each ONT transmits one or more data bursts during an assigned time slot. The TDM transmission scheme is conveyed to each of the ONTs as a time slot map. The TDM transmission scheme enables the ONTs to share time over the optical network without interfering with one another.

Demands upon passive optical networks continue to increase, including the need for faster data rates and more efficient management of data transmission over the upstream portion of the network. In an effort to efficiently manage the upstream portion of the network, it is desirable to reduce the delay between data bursts from successive ONTs. As the delay time or downtime between successive data bursts decreases, the potential increases that successive data bursts from different ONTs may overlap. An OLT is unable to correctly receive overlapping data bursts transmitted from different ONTs. Thus, when data bursts overlap the data is corrupt and lost.

Optical network terminals typically include an optical receiver and an optical transmitter joined to circuitry that is configured to carry out the functions and features of the terminal. The optical transmitter and receiver conveys and receives serialized optical data bursts to and from, respectively, the network. It may be desirable that the optical network convey optical data bursts at a bit rate over 1 gigabit per second. It has been proposed to implement media access control (MAC) operations on a field programmable gate array (FPGA) device. However, FPGA devices that are capable of receiving data bursts at very high data rates, in excess of 1 Gigabit per second, are very expensive. When multiple transmitters, receivers and FPGA devices are utilized in a single application, the cost of the overall system may become prohibitively expensive.

Conventional FPGA devices exist that include a serializer/deserializor (SERDES) module integrated therein, where the SERDES module is configured to convert data between serial and parallel channels. However, the conventional FPGA devices that include integrated SERDES modules have not been shown to be able to meet jitter requirements associated with high speed passive optical networks.

A need remains for improved methods and apparatus for properly aligning data bursts with associated time slots during transmission over a passive optical network. Further, a need remains for improved methods and apparatus that utilize FPGA devices that receive and transmit MAC related data bursts at less than 1 gigabit per second.

### BRIEF DESCRIPTION OF THE INVENTION

In accordance with certain embodiments, an optical network terminal (ONT) is provided that comprises a processor module, a serializer module and an optical transmitter. The processor module is configured to generate data bursts that are associated with time slots in a time division multiplexing (TDM) transmission scheme. The processor module outputs the data bursts over parallel channels to the serializer module that serializes the data bursts and outputs serial data bursts over a serial channel. The serializer module has a latency representing an amount of time for each of the data bursts to propagate through the serializer module from the parallel channels to the serial channel. The optical transmitter is joined to the serial channel and converts the serial data bursts to optical data bursts. The processor module determines a latency of the serializer module and controls the optical transmitter based on the latency of the serializer module.

Optionally, the processor module may provide an enables/disable signal that turns on and off the optical transmitter in order to align the optical data bursts with the corresponding time slots in the TDM transmission scheme. The optical transmitter includes a data input that is joined to the serial channel from the serializer module and an enable/disable input that is controlled by the processor module to enable the optical transmitter. The processor module may directly drive the enable/disable input. As a further option, a data transition ID module may be provided to directly drive the enable/disable input of the optical transmitter based in part on the serial channel and in part on a burst enable signal from the processor module. The data transition ID module set by the serial data burst and cleared by the burst enable signal. The enables/disable input of the optical transmitter is joined to the output of the data transition ID module and is turned on and off based on the serial data bursts which, in turn, enable the optical transmitter when the serial data bursts change to an enable or data state.

Optionally, the processor module may include a field programmable gate array device that may represent a distinct and separate component from the serializer module.

In accordance with an alternative embodiment, an optical network terminal (ONT) is provided that comprises a processor module, a serializer module and an optical transmitter. The processor module is configured to generate data bursts that are output over parallel channels from the processor module. The serializer module receives the data burst over the parallel channels and serializes the data bursts to outputs serial data bursts over a serial channel. The optical transmitter is joined to the serial channel and converts the serial data bursts to optical data bursts. The optical transmitter includes a data input that is joined to the serial channel output by the serializer module. The processor module provides a burst enable signal to enable, at least in part, the optical transmitter. Optionally, the serial data bursts may also be used to enable the optical transmitter.

In accordance with an alternative embodiment, a method is provided for controlling timing of data bursts from an optical network terminal (ONT). The method includes generating data bursts associated with at least one time slot in a time division multiplexing transmission scheme, where the data bursts are conveyed over parallel channels. The method further includes serialized in the data bursts from the parallel channels to outputs serial data bursts over a serial channel. The serializing operation has a latency representing an amount of time for each of the data bursts to be serialized from the parallel channels to the serial channel. The method further includes performing an electrical to optical (E/O) conversion of the serial data bursts to optical data bursts, determining the latency of the serializing operation and controlling E/O conversion based on the latency of the serializing operation.

### BRIEF DESCRIPTION OF THE DRAWINGS

FIG. 1 illustrates a block diagram of a passive optical network that may be implemented in accordance with an embodiment of the present invention.

FIG. 2 illustrates a block diagram of an optical network terminal formed in accordance with an embodiment of the present invention.

FIG. 3 illustrates a block diagram of an optical network terminal formed in accordance with an alternative embodiment of the present invention.

FIG. 4 illustrates the timing diagram associated with an exemplary operation of the block diagram of FIG. 3.

### DETAILED DESCRIPTION OF THE INVENTION

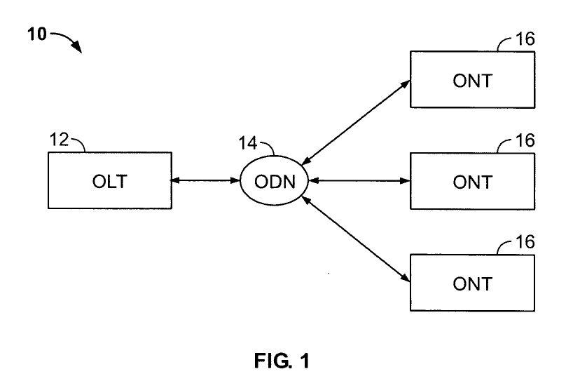

FIG. 1 illustrates a block diagram of a passive optical network (PON) 10 formed in accordance with an embodiment of the present invention. The PON 10 includes an optical line terminal (OLT) 12 joined through an optical distribution network (ODN) 14 to a plurality of optical network terminals (ONTs) 16. The ODN 16 includes at least one passive optical splitter that, for downstream communications, splits optical data bursts between multiple ONTs 14. The passive optical splitter combines, for upstream communications, any overlapping or simultaneously received data bursts. During initialization, the OLT 12 distributes a map identifying a time division multiplexing (TDM) transmission scheme, in which each ONT 16 is assigned one or more time slots during which the ONT 16 may uniquely transmit optical data bursts upstream to the OLT 12. The ONTs 16 manage transmission, therefrom, each optical data bursts to align with the associated time slot to avoid overlap between successive data bursts in adjacent time slots.

The ITU-T recommendation, G.984, describes the operation of a Gigabit passive optical network (GPON) optical distribution network. In a PON distribution system, the recommendation indicates that up to 128 ONTs 16 may communicate with a single OLT 12. The data transmission is broadcast from the OLT 12 to every ONT 16 in the downstream direction. In the upstream direction, however, the ONTs 16 use a time division multiplexing protocol to individually communicate to the OLT 12. When a given ONT 16 is bursting data upstream, all other ONTs 16 should be silent in order for the OLT 12 to receive the data burst from the transmitting ONT 16. If the timing of the upstream data bursts transmitted by each ONT 16 are misaligned, the data will be corrupted and lost at the OLT 12 causing the payload to be discarded. A safeguard of time is defined between each upstream burst to mitigate the likelihood of data overlap, however some types of OLTs 12 have burst receivers that expect “guard bits” to be transmitted by each ONT 16 in order to reset the burst receiver of the OLT 12. Therefore, ensuring that the lasers of each ONT 16 are turned on and turned off within a tight window of time impacts the performance of the ODN 14.

The ONTs 16 each perform media access control (MAC) functions. In the embodiment of FIG. 1, the ONTs 16 utilize field programmable gate arrays that are programmed to perform MAC functions such as framing data and data extraction.

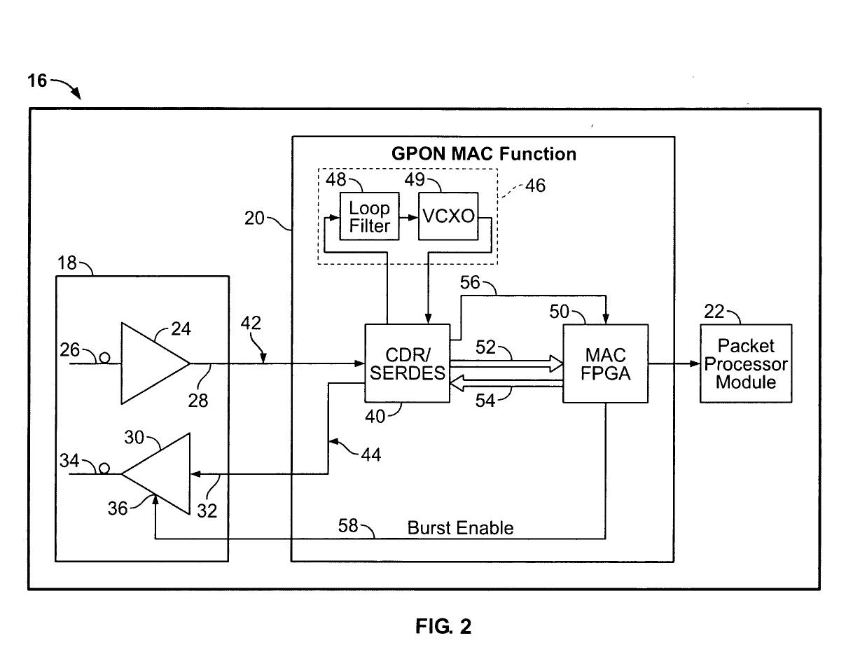

FIG. 2 illustrates a block diagram of an ONT 16 formed in accordance with an embodiment of the present invention. The ONT 16 includes an optical module 18 such as a diplexer or triplexor, MAC functional module 20 and a packet processor module 22. In the example of FIG. 2, the SERDES module 40 and processor module 50 represent distinct and separate components. The optical module 18 includes a receiver 24 that converts incoming optical data 26 into a serialized data stream 28 during an optical to electrical (E/O) conversion. By way of example only, the optical data 26 may have a wavelength of approximately 1490 nm and a downstream bit rate of approximately 2.488 Gbps. By way of example only, the serialized data stream 28 may represent a low voltage differential signal (LVDS) or low-voltage paired emitter coupled logic (LVPECL) with a downstream bit rate of approximately 2.488 Gpbs.

The optical module 18 includes a transmitter 30 that receives and converts serialized data bursts 32 to optical data bursts 34 through electrical to optical (E/O conversion. By way of example, the serialized data burst 32 may be formatted as an LVDS or LVPECL signal and have an upstream bit rate of 1.244 Gbps. By way of example, the transmitter 30 may output the optical data bursts 34 at a wavelength of approximately 1310 nm and have an upstream bit rate of approximately 1.244 Gbps. The transmitter 30 is controlled by an enable/disable signal 36 that turns ON and OFF the transmitter 30.

The MAC functional module 20 includes a serializer/deserializer (SERDES) module 40 that is joined to a jitter attenuation block 46 and a MAC processor module 50. In the example of FIG. 2, the SERDES module 40 and processor module 50 represent distinct and separate components. The processor module 50 is linked to the SERDES module 40 by incoming parallel channels 52 and outgoing parallel channels 54. A jitter attenuation block 46 is joined to the SERDES module 40 and includes a loop filter 48 and a voltage controlled oscillator 49. The loop filter 48 and voltage controlled oscillator 49 are connected in series with one another and cooperate with the SERDES module 40 to limit attenuation of the serialized data stream 28 that is received over the incoming serial channel 42.

For downstream transmissions, the SERDES module 40 receives the serialized data stream 28 over incoming serial channel 42 and separates/converts the serialized data stream 28 into at least two incoming parallel channels 52. For upstream transmissions, the SERDES module 40 receives at least two outgoing parallel channels 54 of data bursts and merges the data bursts into a single common data stream that is transmitted as the serialized data burst 32 over the outgoing serial channel 44. A single data burst from the processor module 50 may include pre-guard data, guard data, a preamble, CRC and one or more frames of data. Data includes, among other things, packet-based data and telephoning data.

The processor module 50 may represent a programmable circuit or device (e.g. a field programmable gate array device) or a combination of circuits or devices and the like. The processor module 50 performs the functions associated with media access control (MAC), such as data framing and data extraction, among other things. The processor module 50 receives a clock signal 56 from the SERDES module 40. The processor module 50 receives continuous data over the parallel channels 52, processes the data, and outputs the data to the packet processor module 22. The incoming bit rate, at which data bursts are received over the parallel channels 52 may be less than 1 Gbps. The packet processor module 22 identifies packets within the incoming data bursts based on the predefined packet protocol and performs various operations upon the underlying data.

In connection with MAC functions, the processor module 50 generates outgoing data bursts to be conveyed over the parallel channels 54. The outgoing bit rate at which data bursts are produced over the outgoing parallel channels 54 may be less than 1 Gpbs. By way of example only, the parallel channels 52 and 54 may include four channels that each convey data at a bit rate of 622 Mbps, 8 channels that each convey data at a bit rate of 31 Mbps, 16 channels that convey data at a bit rate of 155 Mbps and the like. Optionally, the parallel channels 52 may include fewer or more channels than the number of parallel channels 54.

The processor module 50 also generates a burst enable signal 58 that is delivered as enable/disable signal 36 to the transmitter 30. The burst enable signal 58 turns the transmitter 30 on and off to align each optical data burst 34 with a corresponding time slot within the time division multiplexing transmission scheme. The burst enable signal 58 and corresponding the data burst over parallel channels 54 may be generated simultaneously by the processor module 50. Alternatively, the processor module 50 may delay setting the burst enable signal 58 to a transmit enable state by a predetermined delay time following output of the data burst onto parallel channels 54. The predetermined delay time corresponds to a latency associated with the SERDES module 40, where the latency represents an amount of time for each of the data burst to propagate through the SERDES module 40 from the parallel channels 54 to the serial channel 44. The latency associated with the SERDES module 40 may be predefined, updated manually, automatically periodically updated or continuously updated throughout operation of the ONT 16. The latency may be dynamically determined burst by burst or dynamically determined at periodic calibration times. The latency through the SERDES module 40 may vary over time and from device to device.

The processor module 50 associates each data burst to be conveyed over the parallel channels 54 with one or more time slots assigned to the ONTs 16. The time slots assigned to the ONTs 16 are defined based upon a map received from an OLT 12 (FIG. 1). The processor module 50 controls the time at which each optical data burst 34 is transmitted from the transmitter 32, through use of the burst enable signal 58, in order to properly align each optical data burst 34 with a corresponding time slot.

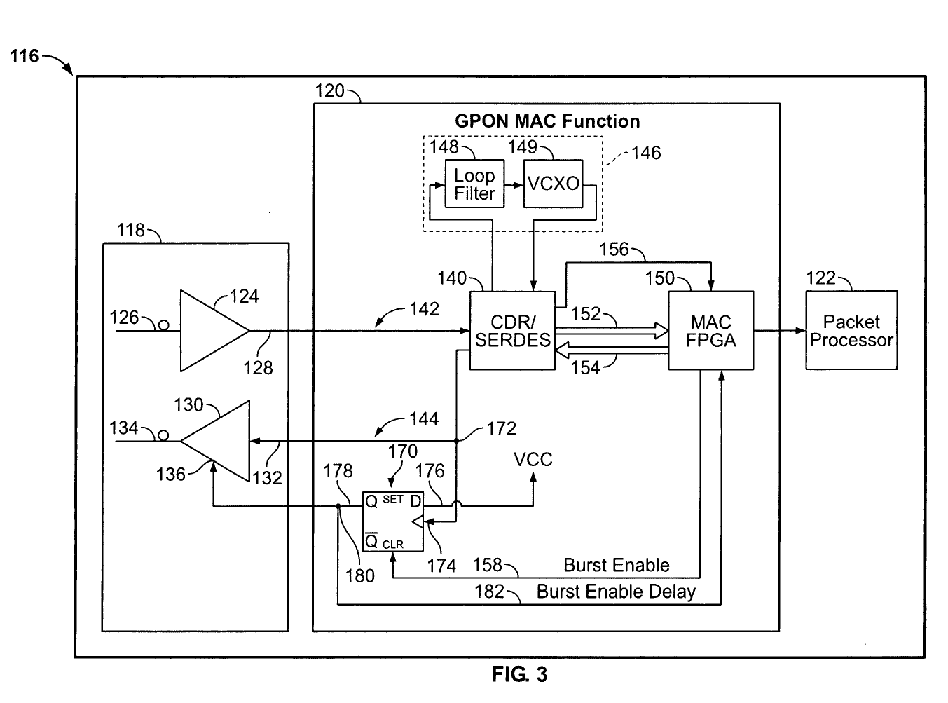

FIG. 3 illustrates a block diagram of an ONT 116 formed in accordance with an alternative embodiment of the present invention. The ONT 116 includes an optical module 118, such as a diplexer or triplexor, MAC functional module 120 and a packet processor module 122. In the example of FIG. 3, the SERDES module 140 and processor module 150 represent distinct and separate components. Alternatively, the SERDES module 140 and processor module 150 may be formed on a common integrated circuit. As a further option, the SERDES module 140 may be provided as a serializer device and a deserializer device as separate and distinct components. The optical module 118 includes a receiver 124 that converts incoming optical data 126 into a serialized data stream 128 during an O/E conversion. The optical module 118 includes a transmitter 130 that receives and converts serialized data bursts 132 to optical data bursts 134. The transmitter 130 receives an enable/disable signal 136 that turns ON and OFF the transmitter 130.

The serializer/deserializer (SERDES) module 140 is joined to a jitter attenuation block 46 and the processor module 150. The MAC functional module 120 also includes a data transition ID module 170 that is joined to the processor module 150 and the SERDES module 140. The processor module 150 is linked to the SERDES module 140 by parallel channels 152 and parallel channels 154. A jitter attenuation block 146 is joined to the SERDES module 140 and includes a loop filter 148 and a voltage controlled oscillator 149 that cooperate with the SERDES module 140 to limit attenuation of the serialized data stream 128.

The SERDES module 140 receives the serialized data stream 128 over incoming serial channel 142 and separates/converts the serialized data stream 128 into at least two incoming parallel channels 152 of data bursts. The SERDES module 140 also receives data bursts over at least two outgoing parallel channels 154 and merges the parallel data bursts into a single common data stream that is transmitted as the serialized data bursts 132 over the serial channel 144. The processor module 150 performs the functions associated with media access control, such as data framing and data extraction, among other things. The processor module 150 receives a clock signal 156 from the SERDES module 140. The processor module 150 continuous data over the incoming parallel channels 152, processes the data, and outputs the data to the packet processor module 122. In connection with MAC functions, the processor module 150 generates outgoing data bursts to be conveyed over the outgoing parallel channels 154. The processor module 150 records a point in time (FPGA data out time) at which each data burst is output over parallel channels 154.

The serialized data bursts 132 produced by the SERDES module 140 are also provided at node 172 to a clock input 174 of the data transition ID module 170. A data input 176 of the data transition ID module 170 is tied to high-voltage (VCC), while output 178 is supplied as the enable/disable input 136 to the transmitter 130. At node 180, output 178 of the data transition ID module 170 is fed back as a burst enable delay 182 to the processor module 150. The processor module 150 generates a burst enable signal 158 that is delivered to a clear (CLR) input of the data transition ID module 170. The processor module 150 changes the burst enable signal 158 to a low (enable) state to enable the data transition ID module 170. Once the data transition ID module 170 is enabled, when the serialized data bursts change from an empty state to a data state, the state change directs the data transition ID module 170 to clock through and store the VCC value applied at the input 176. Once the VCC value is clocked and stored, the output 178 switches state to equal VCC (which corresponds in this example to an enable state). The output 178 supplies an enable signal to the optical transmitter 130. The enable signal is split at node 180 and supplied to the processor module 150 as a burst enable delay 182.

The processor module 150 records a point in time (FPGA data out time) at which each data burst is output over parallel channels 154. The processor module 150 uses the burst enable delay 182 to determine a point in time (SERDES data out time) at which a data burst is output from the SERDES module 140 over serial channel 144. The processor module 150 then determines a delay interval between the FPGA data out time and the SERDES data out time, where the delay interval constitutes the measured latency of the SERDES module 140. The measured latency of the SERDES module 140 represents the time needed for each data bursts to propagate through the SERDES module 140 from the parallel channels 154 to the serial channel 144. The processor module 150 dynamically measures the latency of the SERDES module 140 in real-time during processing (e.g., serialization, E/O conversion and/or laser transmission) of a data burst. The processor module 150 uses the measured latency to determine when to set and reset the burst enable signal 158. The burst enable signal 158 turns the transmitter 130 on and off to align the optical data burst 134 with corresponding time slots within the TDM transmission scheme. The burst enable signal 158 and the corresponding data burst generated over parallel channels 154 may be generated simultaneously by the processor module 150.

The processor module 150 manages the alignment of data bursts utilizing a known transition in the upstream data. More specifically, in accordance with the exemplary frame format, the upstream data (to be conveyed over parallel channels 154 to the SERDES module 140) are maintained as all zeros until a data burst is to be transmitted in a corresponding time slot. When the ONT 116 is not transmitting data, a fixed pattern of all zeros is fed into the SERDES module 140 resulting in a serial stream of all zeros at the output of the SERDES module 140. At the same time, the burst enable signal 158 is set high by the processor module 150, causing the output 178 of the data transition ID module 170 to be cleared to zero. When the output 178 of the data transition ID module 170 is reset to a low state, the enable/disable signal 136 is also low (disabled), which turns off an optical laser in the transmitter 130.

When it is time to convey the data burst, the processor module 150 precedes the data burst with a series of guard bits that are all “ones”. Prior to sending the guard bits, the processor module 150 feeds a logic pattern of ones into the SERDES module 140 as “preguard bits” and also clears the burst enable signal 158 by changing it to a low state. The length of the preguard bit pattern corresponds to the delay required to turn on the laser in the transmitter 130 and is programmable via a register in the processor module 150. The pre-guard bit pattern is not transmitted upstream by the transmitter 130, because the pre-guard bit pattern only lasts as long as the delay of the laser to become active.

At the beginning of the preguard bit pattern, the outgoing serial channel changes state from a zero to a one. The rising edge of the state change between the zeros and the pre-guard bit pattern is supplied to the clock input 174 of the data transition ID module 170 (such as a MC10EP51 from On Semiconductor). In response to the state change, the data transition ID module 170 turns the laser on in the transmitter 130. The output of the data transition ID module 170 is also fed back to the processor module 150 to provide a signal for an accurate measure of the delay through the SERDES module 140. The processor module 150 measures the latency through the SERDES module 140 and the data transition ID module 170 via a series of shift registers operating on multiple phases of the clock signal 156. The clock signal 156 may be operated at 311 MHz as one example which may be accomplished by simply dividing down the 622 MHz input clock (if the data bus is 4 bits wide), or multiplying up the 155 MHz input clock with an internal PLL or DCM (if the data bus is 16 bits wide).

Once the latency through the SERDES module 140 is known, the processor module 150 matches the laser shut-off time of the transmitter 130 with the serial data by delaying the burst enable signal 158 by the same amount of time that was measured as the latency. Since the latency through the SERDES module 140 may be measured for every burst time, the control over the laser is dynamic and eliminates any variance of the latency due to changes in voltage, temperature or clock drift. In accordance with the foregoing operations, the serialized data bursts 132 over outgoing serial channel 144 enables the transmitter 130, while the burst enable signal 158 disables the transmitter 130.

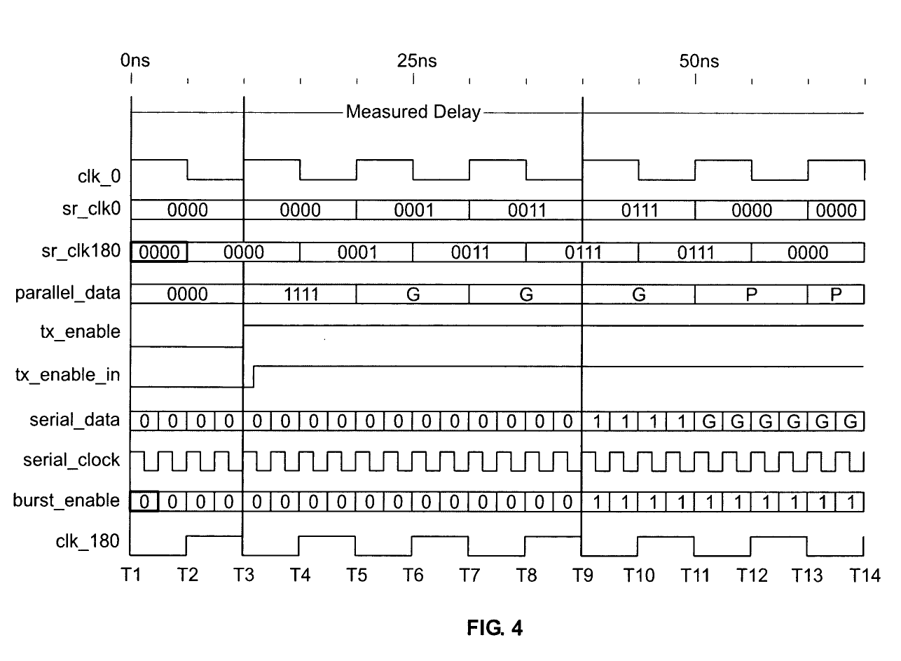

FIG. 4 illustrates a time diagram for an exemplary operation of the ONT 116 of FIG. 3. In FIG. 4, a clock signal clk_0 is utilized by the processor module 150, sr_clk0 corresponds to values stored in a shift register in the processor module 150. The processor module 150 increments the shift register sr_clk0 based on the clock signal (clk_0). Between times T1 and T5, the shift register sr_clk0 stores 0000. At time T5, the shift register sr_clk0 increments one to store 0001. At time T7, the shift register sr_clk0 increments one to store 0011. At time T9, the shift register sr_clk0 increments one to store 0111. The processor module 150 also shifts the clock signal clk_0 180 degrees at denoted by clk_180. A shift register sr_clk180 is incremented 180 degrees out of phase with the clock signal 156 clk_0 based on the clk_180. Thus, the shift register sr_clk180 is incremented by one at T4, T6, T8, T10, T12, etc. between (0001), (0011), (0111), (1111), etc.

A portion of a data bursts over parallel channel 154 is shown along the line denoted parallel_data. In the example of FIG. 4, a 4-bit data bus is used. The parallel_data begins as zeros, and switches to a preguard bit pattern of all ones at time T3. The parallel_data changes to a guard bit pattern (denoted G) at time T5 and the guard bit pattern is repeated at times T7 and T9, followed by a preamble bit pattern (denoted P) at times T11 and T13. When the processor module 150 outputs the preguard bit pattern at time T3, the processor module 150 also sets a transmit enable (tx_enable) signal.

The timing diagram also includes a line denoted serial_data which corresponds to the data output over outgoing serial channel 144. The serial_data remains low (zeros) until time T9, after which it switches to a high (ones) state. The time interval between time T3 and time T9 represents the latency of the SERDES module 140. A serial clock signal (serial_clock) is used by the SERDES module 140 to form the bit rate of the serialized data burst 132. The clock signal clk_0 used by the processor module 150 to output data bursts over parallel channels 154 is slower than the clock signal serial_clock used by the SERDES module 140 to output data bursts over outgoing serial channel 144. The burst enable signal 158 is shown in FIG. 4 as burst_enable and switches from the low to the high state at time T9.

Referring to FIG. 3, the burst enable delay signal 182 may be asynchronous to the clock domains on a chip, while the delay should be monotonically increasing to be measured. The data transition ID module 170 may have a worst-case clock to out of 500 ps. Given that the adjacent rising and falling edges of the 311 MHz clock are about 1.5 ns apart (3 ns/2), a metastable result on one clock edge will not produce a result that is inconsistent with the shift register operating on the other clock edge. Regardless of the resulting value in the shift register flip flop, the subsequent clock edge will produce a deterministic result, sampling the burst enable delay high and ending the measurement. Since the purpose of the circuit is to find the rising edge of burst enable delay, the shift registers are preloaded with zeros upon reset or during non-burst times.

While the invention has been described in terms of various specific embodiments, those skilled in the art will recognize that the invention can be practiced with modification within the spirit and scope of the claims.

What is claimed is:

1. An optical network terminal (ONT), comprising:
a processor module configured to generate data bursts, the data bursts being associated with time slots within a time multiplexed transmission scheme, the processor module outputting the data bursts over parallel channels;
a serializer module receiving the data bursts over the parallel channels and serializing the data bursts to output serial data bursts over a serial channel, the serializer module having a latency representing an amount of time for each of the data bursts to propagate through the serializer module between the parallel channels and the serial channel; and
an optical transmitter joined to the serial channel for converting the serial data bursts to optical data bursts, the processor module determining the latency of the serializer module and controlling the optical transmitter based on the latency of the serializer module.

2. The terminal of claim 1, wherein an output of the optical transmitter is configured to convey the optical data bursts, over a shared network, upstream to an optical line terminal (OLT).

3. The terminal of claim 1, wherein the data bursts are conveyed over each of the parallel channels at less than 1 Gbps and the serial data bursts are conveyed over the serial channel at over 1 Gbps.

4. The terminal of claim 1, wherein the processor module dynamically aligns each of the optical data bursts with the associated time slot on a burst by burst basis based on the latency of the serializer module.

5. The terminal of claim 1, wherein the processor module provides an enable/disable signal to turn on and off the optical transmitter to align the optical data bursts with corresponding time slots in the time multiplexed transmission scheme.

6. The terminal of claim 1, wherein the optical transmitter includes a data input joined to the serial channel from the serializer module, the enable/disable input turning on the optical transmitter based on a state change of the serial data bursts conveyed over the serial channel.

7. The terminal of claim 1, wherein the processor module includes a field programmable gate array device.

8. The terminal of claim 1, wherein the processor module performs at least one of media access control (MAC) functions, data framing and data extraction.

9. The terminal of claim 1, wherein the serializer module and processor module are distinct and separate components.

10. The terminal of claim 11, further comprising a data transition ID module temporarily storing the serial data bursts before output to the optical transmitter, wherein the optical transmitter includes a data input and an enable/disable input, the enable/disable input being joined to the data transition ID module and receiving therefrom the serial data bursts conveyed over the serial channel to enable the optical transmitter.

11. An optical network terminal (ONT), comprising:
a processor module configured to generate data bursts, the processor module outputting the data bursts over parallel channels;
a serializer module receiving the data bursts over the parallel channels and serializing the data bursts to output serial data bursts over a serial channel; and
an optical transmitter joined to the serial channel for converting the serial data bursts to optical data bursts, wherein the optical transmitter includes a data input and an enable/disable input, the data input being joined to the serial channel output by the serializer module, the enable/disable input turning on the optical transmitter based on a state change of such that the serial data bursts conveyed over the serial channel enable the optical transmitter.

12. The terminal of claim 11, wherein the optical transmitter is enabled by a state transition in the serial data bursts.

13. The terminal of claim 11, further comprising a data transition ID module temporarily storing a set value as an output to the enable/disable input of the optical transmitter when the serial data burst changes state to a data state.

14. The terminal of claim 11, further comprising D flip flop logic for temporarily storing a state transition of the serial data burst, the state transition being provided to the enable/disable input of the optical transmitter.

15. The terminal of claim 11, wherein the serializer module has a latency representing an amount of time for each of the data bursts to propagate through the serializer module from the parallel channels to the serial channel, the processor module determining the latency of the serializer module and controlling the optical transmitter based on the latency.

16. The terminal of claim 11, wherein an output of the optical transmitter is configured to convey the optical data bursts, over a shared network, upstream to an optical line terminal (OLT).

17. The terminal of claim 11, wherein the serializer module has a latency representing an amount of time for each of the data bursts to propagate through the serializer module from the parallel channels to the serial channel, the processor module dynamically aligning each of the optical data bursts with an associated time slot on a burst by burst basis based on the latency of the serializer module.

18. The terminal of claim 11, wherein the processor module includes a field programmable gate array.

19. The terminal of claim 11, wherein the processor module performs at least one of media access control (MAC) functions, data framing and data extraction.

20. The terminal of claim 11, wherein the serializer module and processor module represent separate components.

21. A method for controlling timing of data bursts from an optical network terminal (ONT), the method comprising:
generating data bursts associated with at least one time slot in a time multiplexed transmission scheme, the data bursts being conveyed over parallel channels;
serializing the data bursts from the parallel channels and to output serial data bursts over a serial channel, the serializing having a latency representing an amount of time for each of the data bursts to be routed from the parallel channels to the serial channel;
performing electrical to optical (E/O) conversion of the serial data bursts to optical data bursts;
determining the latency of the serializing; and
controlling the E/O conversion based on the latency of the serializing.

22. The method of claim 21, further comprising conveying the optical data bursts, over a shared network, upstream to an optical line terminal (OLT).

23. The method of claim 21, wherein the data bursts are conveyed over each of the parallel channels at less than 1 Gbps and the serial data bursts over the serial channel at over 1 Gbps.

24. The method of claim 21, further comprising dynamically aligning each of the optical data bursts with an associated time slot on a burst by burst basis based on the latency of the serializing.

25. The method of claim 21, further comprising provides an enable/disable signal to turn on and off the E/O conversion to align the optical data bursts with corresponding time slots within the time multiplexed transmission scheme.

26. The method of claim 21, further comprising identifying a data transition of the serial data bursts from a fixed pattern of all zeros such that the serial data bursts conveyed over the serial channel enable the E/O conversion.

27. The method of claim 21, further comprising utilizing the serial data bursts to turn on transmission of the optical data bursts.
